(19) United States
(12) Patent Application Publication
(10) Pub. No.: US 2015/0168628 A1
(43) Pub. Date: Jun. 18, 2015

(54) MAT TOY

(71) Applicant: D.J. TOYS ENTERPRISE CORP., Taichung (TW)

(72) Inventor: Li-Yang NIU, Taichung (TW)

(73) Assignee: D.J. TOYS ENTERPRISE CORP., Taichung (TW)

(21) Appl. No.: 14/133,270

(22) Filed: Dec. 18, 2013

(51) Int. Cl. F21V 8/00; F21V 33/00; A63H 33/22

(52) U.S. Cl. CPC G02B 6/0011; A63H 33/22; F21V 33/008

(57) ABSTRACT

A mat toy includes a mat and an illuminating module on the mat. The illuminating module has a light guide plate. The light guide plate includes at least one switch and at least one illuminating member. One side of the mat is provided with a controller. The controller is electrically connected with the switch and the illuminating member. The present invention uses the switch to activate the illuminating member instead of the carbon black to conduct electricity. The present invention can overcome the shortcoming that the carbon black is cracked easily and unable to conduct electricity when the mat is folded for storage.

### BACKGROUND OF THE INVENTION

1. Field of the Invention

The present invention relates to a mat toy.

2. Description of the Prior Art

A mat toy, such as a dance mat or a whac-a-mole mat, comprises a mat and a controller disposed at one side of the mat. The mat has a bottom fabric. The bottom fabric is stacked with a first carbon black layer, a gauze layer, a second carbon black layer and a top fabric in sequence. The first carbon black layer and the second carbon black layer are electrically connected with the controller. The bottom fabric is provided with a plurality of LEDs. The LEDs are electrically connected with the controller. When the users presses the mat, the portions of the first carbon black layer and the second carbon black layer relative to the woven holes of the gauze layer will get contact with each other for the controller to bring the corresponding control actions, such as to drive the LEDs to illuminate, so as to provide a game effect.

However, the aforesaid mat toy uses carbon black to conduct electricity to trigger the controller. This way has some shortcomings. Because the mat is large in size, the mat needs to be folded for storage. This causes that the first carbon black layer and the second carbon black layer may crack and are unable to conduct electricity, so the mat toy is damaged. The LEDs are dot light sources. If a large range of illumination is required, the mat must be provided with many LEDs. This consumes electricity very much and increases production cost greatly. Besides, the LEDs are electrically connected with the controller through wires, so it is not easy to arrange the wires when producing the mat toy. Accordingly, the inventor of the present invention has devoted himself based on his many years of practical experiences to solve this problem.

### SUMMARY OF THE INVENTION

The primary object of the present invention is to provide a mat toy which is durable, won't be damaged with ease, has a better illuminating effect, and can be produced easily.

According to one aspect of the present invention, the mat toy comprises a mat, at least one illuminating module, and a controller. The illuminating module is disposed on the mat and has a light guide plate. The light guide plate comprises at least one switch and at least one illuminating member. The controller is disposed at one side of the mat and electrically connected with the switch and the illuminating member.

According to another aspect of the present invention, the mat toy comprises a mat, at least one illuminating module, a controller, and an infrared emitter. The illuminating module is disposed on the mat and has a light guide plate. The light guide plate comprises at least one illuminating member. The controller is disposed at one side of the mat and electrically connected with the illuminating member. The controller further comprises an infrared receiver thereon. The infrared emitter is disposed at another side of the mat and corresponds in position to the infrared receiver.

Accordingly, the switch of the mat toy of the present invention is triggered by pressing the light guide plate for the controller to drive the illuminating member to illuminate. Alternatively, the controller is activated by using an infrared induction way to drive the illuminating member to illuminate. Thus, when the mat is folded for storage, the present invention can overcome the shortcoming that the carbon black is cracked easily and unable to conduct electricity. The present invention is durable and won't be damaged easily. Through the light guide plate to guide light, the present invention provides a plane-illuminating effect. The present invention has a better illuminating effect and decreases the number of the illuminating members to lower power consumption, and the wires can be arranged with ease.

### BRIEF DESCRIPTION OF THE DRAWINGS

FIG. 1 is a perspective view according to a first embodiment of the present invention;

FIG. 2 is an exploded view according to the first embodiment of the present invention;

FIG. 3 is an exploded view of the illuminating module according to the first embodiment of the present invention;

FIG. 4 is a sectional view of the illuminating module according to the first embodiment of the present invention;

FIG. 5 is a sectional view showing operation of the first embodiment of the present invention;

FIG. 6 is a schematic view of the first embodiment of the present invention when in use;

FIG. 7 is a schematic view showing illumination of the illuminating module according to the first embodiment of the present invention;

FIG. 8 is a perspective view according to a second embodiment of the present invention;

FIG. 9 is an exploded view according to a third embodiment of the present invention; and

FIG. 10 is a top view of the illuminating module according to a fourth embodiment of the present invention.

### DETAILED DESCRIPTION OF THE PREFERRED EMBODIMENTS

Embodiments of the present invention will now be described, by way of example only, with reference to the accompanying drawings.

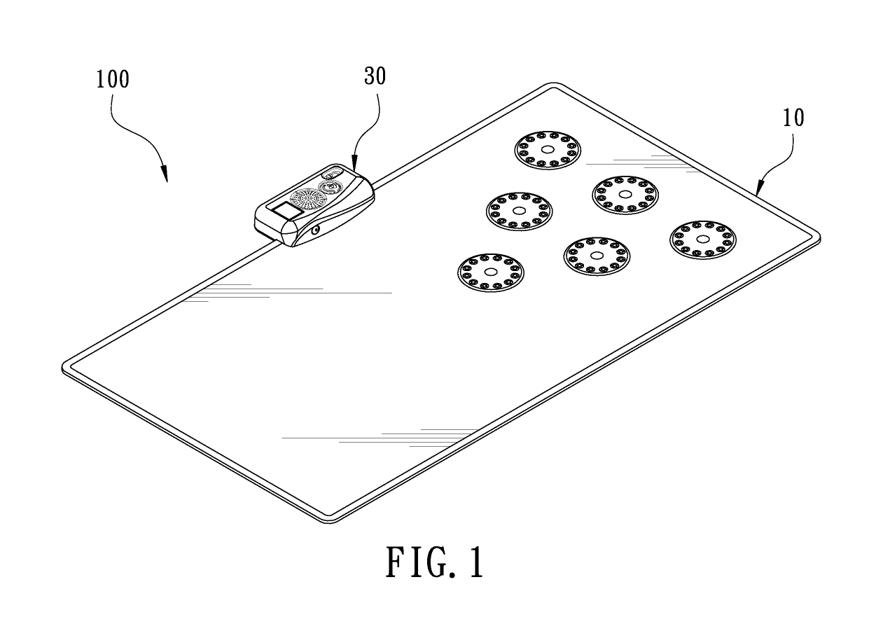

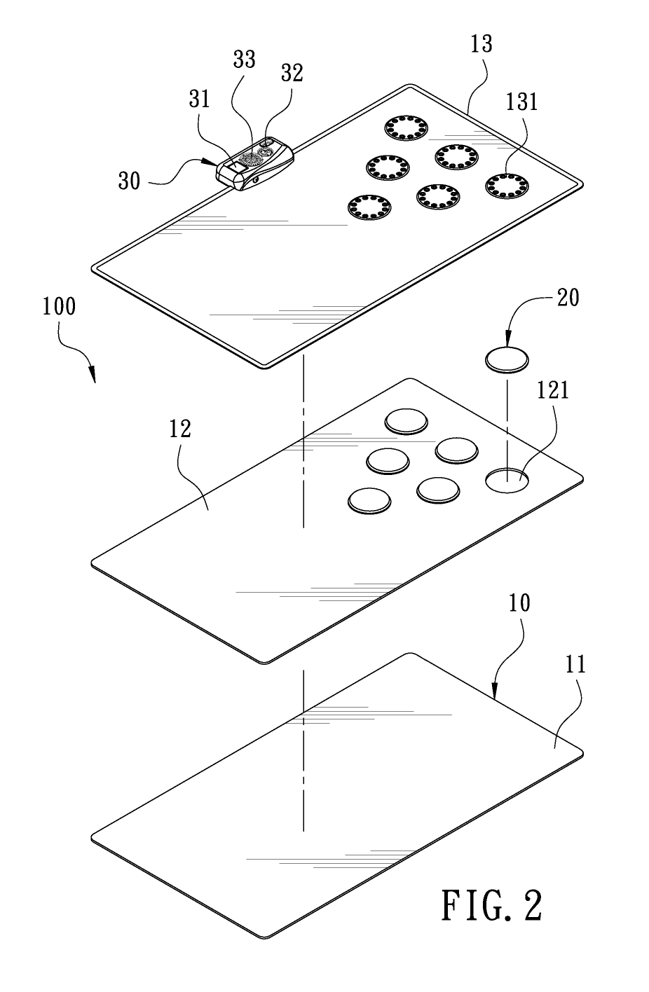

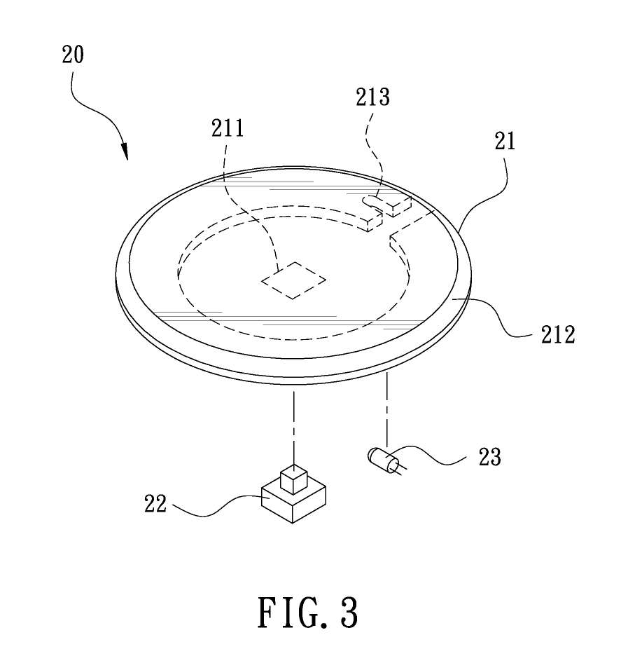

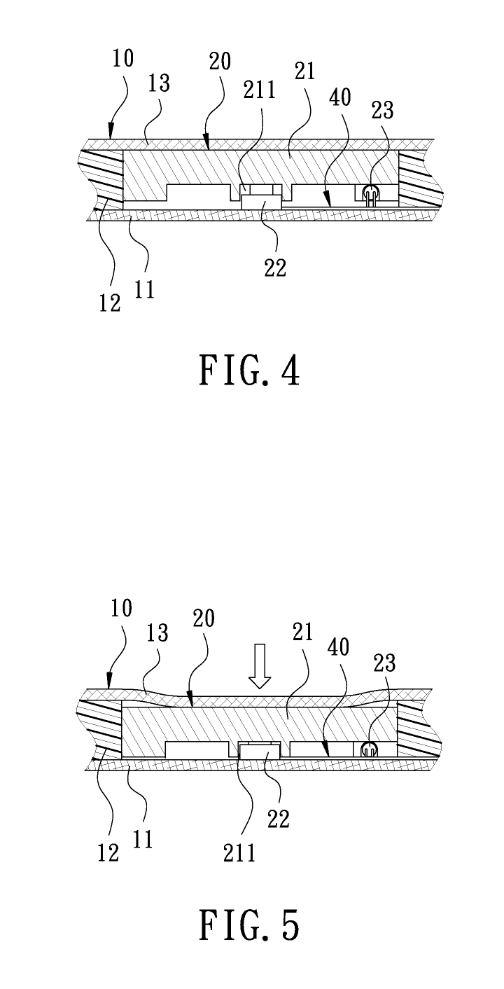

FIG. 1 is a perspective view according to a first embodiment of the present invention. FIG. 2 is an exploded view according to the first embodiment of the present invention. FIG. 3 is an exploded view of the illuminating module according to the first embodiment of the present invention. FIG. 4 is a sectional view of the illuminating module according to the first embodiment of the present invention. The present invention discloses a mat toy 100. The mat toy 100 comprises a mat 10, at least one illuminating module 20, and a controller 30.

The mat 10 comprises a bottom fabric 11, a foam layer 12 stacked on the bottom fabric 11, and a top fabric 13 stacked on the foam layer 12. The foam layer 12 has at least one positioning hole 121. The top fabric 13 comprises a plurality of pattern layers 131 thereon. In this embodiment, the foam layer 12 has a plurality of positioning holes 121.

The illuminating module 20 is disposed on the mat 10 and has a light guide plate 21. The light guide plate 21 comprises at least one switch 22 and at least one illuminating member 23. In this embodiment, the mat toy 100 comprises a plurality of illuminating modules 20. The illuminating modules 20 are disposed in the positioning holes 121 of the foam layer 12, respectively. The light guide plate 21 is shaped to one of a circle and a rectangle. In this embodiment, the light guide plate 21 is shaped to a circle. The light guide plate 21 has an engaging recess 211 at a bottom surface thereof for the switch 22 to be embedded therein. Furthermore, the light guide plate 21 has a light guide portion 212 around a circumferential edge thereof. The light guide portion 212 has a notch 213 thereon for accommodating the illuminating member 23. In this embodiment, the switch 22 is a push switch.

The controller 30 is disposed at one side of the mat 10 and is electrically connected with the switch 22 and the illuminating member 23. In this embodiment, the controller 30 is electrically connected with the switch 22 and the illuminating member 23 through electric wires 40. The electric wires 40 are located between the bottom fabric 11 and the foam layer 12. The controller 30 comprises a control unit 31. The control unit 31 is electrically connected with a mode-switching switch 32 to switch games, such as a drumming mode or a whac-a-mole mode, and a sounding member 33 to provide a sounding effect.

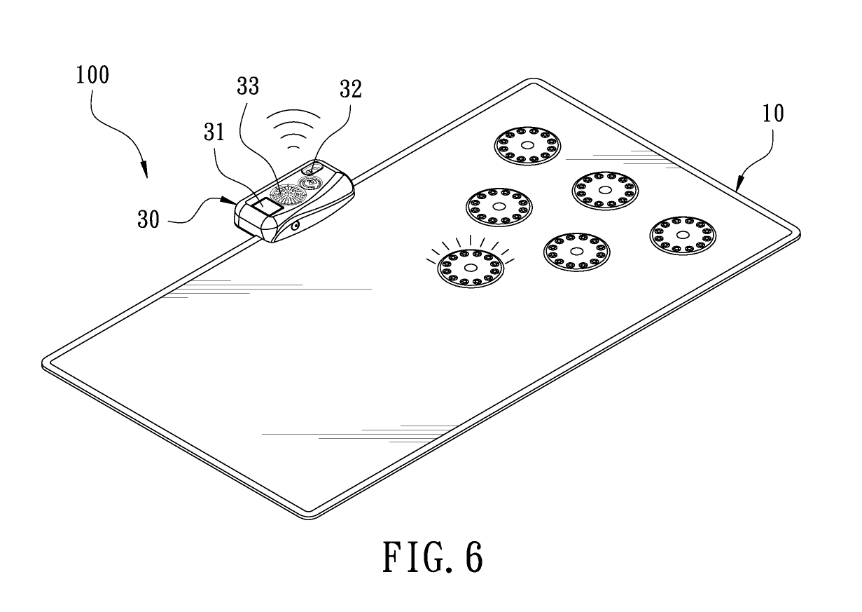

Referring to FIG. 5 and FIG. 6, when the user presses the illuminating module 20, the light guide plate 21 will press the switch 22 for the controller 30 to bring the corresponding control actions. The drumming mode is as an example. As shown in FIG. 6, when the user presses the illuminating module 20 to trigger the controller 30, the controller 30 will drive the illuminating member 23 of the pressed illuminating module 20 to illuminate and drive the sounding member 33 to sound, such that the drumming game is provided. Alternatively, the what-a-mole mode is as an example. The controller 30 first drives the illuminating members 23 of the illuminating modules 20 to illuminate. When the user exactly presses the twinkling illuminating module 20 to trigger the switch 20, the controller 30 will drive the sounding member 33 to sound so that the what-a-mole game is provided. Wherein, the switch 22 of the mat toy 100 of the present invention is triggered by pressing the light guide plate 21 for the controller 30 to bring the corresponding control actions. Thus, when the mat 10 is folded for storage, the present invention can overcome the shortcoming that the carbon black is cracked easily and unable to conduct electricity. The present invention is durable and won't be damaged easily.

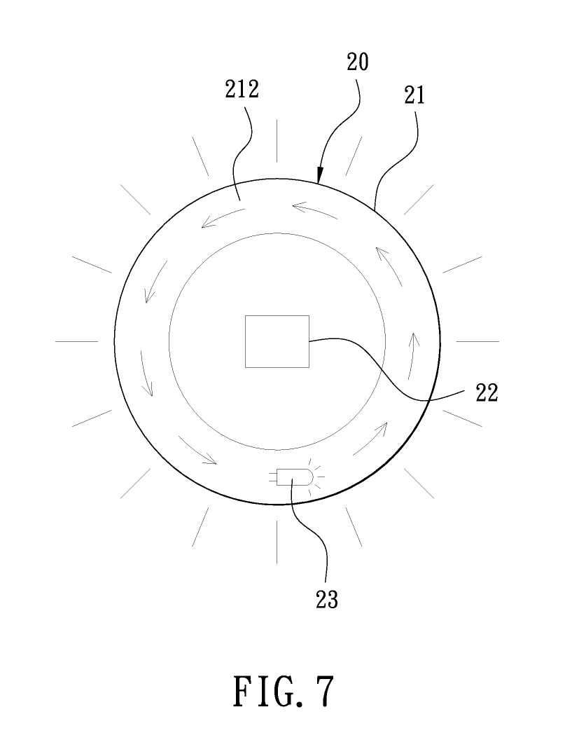

FIG. 7 is a schematic view showing illumination of the illuminating module according to the first embodiment of the present invention. When the illuminating member 23 starts to illuminate, the light will be radiated to the light guide portion 212 of the light guide plate 21. Along with the guide of the light guide portion 212 to surround the light guide plate 21, the light guide plate 21 provides a plane-illuminating effect. Compared to the conventional mat toy which uses LEDs as the light source, the present invention has a better illuminating effect and decreases the number of the illuminating members 23 to lower power consumption, and the wires can be arranged with ease.

It is noted that the illuminating module 20 won't slide by the positioning hole 121 of the foam layer 12 to position the illuminating module 20 and that the wires 40 are disposed between the bottom fabric 11 and the foam layer 12. The foam layer 12 provides a protection effect, preventing the wires 40 from being damaged.

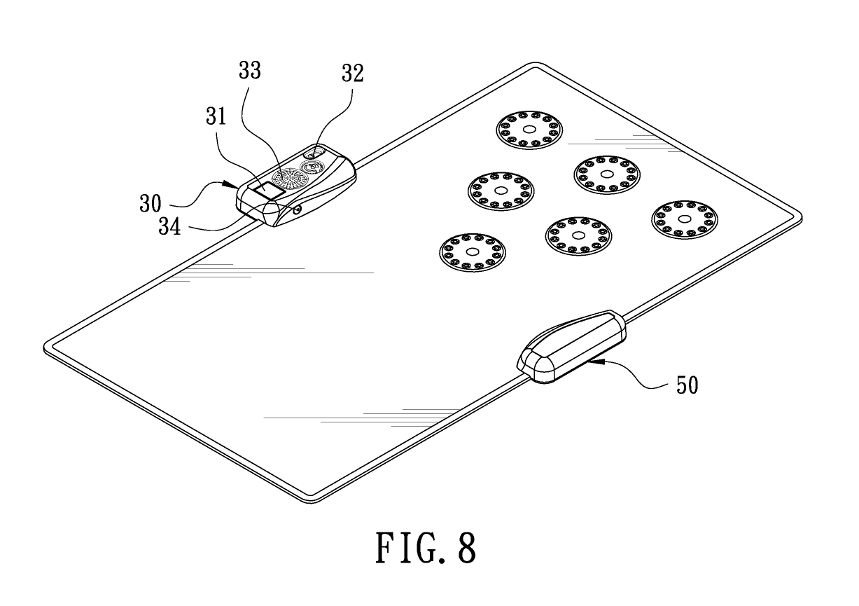

FIG. 8 is a perspective view according to a second embodiment of the present invention. The mat toy 100 of the second embodiment is substantially similar to the first embodiment with the exceptions described hereinafter. This embodiment uses an infrared induction way instead of the switch 22. The controller 30 is provided with an infrared receiver 34. The mat toy 100 further comprises an infrared emitter 50 at another side of the mat 10 and corresponding in position to the infrared receiver 34. Thus, when an object passes between the infrared emitter 50 and the infrared receiver 34, the controller 30 will be triggered to drive the illuminating member 23 to illuminate and to drive the sounding member 33 to sound. The second embodiment also has the same effect as the first embodiment, namely, the present invention can overcome the shortcoming that the carbon black is cracked easily and unable to conduct electricity. Through the illuminating module, the present invention has a better illuminating effect and saves energy. The mat toy 100 of the second embodiment can be used for games different from those of the first embodiment, such as a bowling game, a basket game, a golf game, and so on.

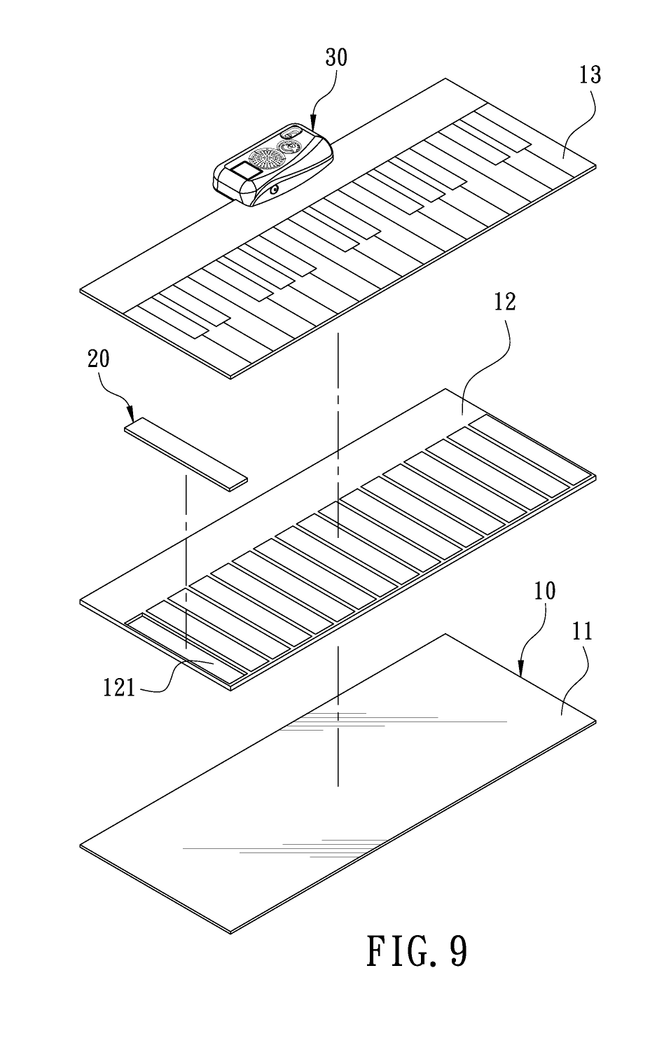

FIG. 9 is a perspective view according to a third embodiment of the present invention. The mat toy 100 of the third embodiment is substantially similar to the first embodiment with the exceptions described hereinafter. The light guide plate 21 has a different shape according to the user's demand. In this embodiment, the light guide plate 21 is shaped to a rectangle. The mat toy 100 of this embodiment can be used to imitate playing the piano.

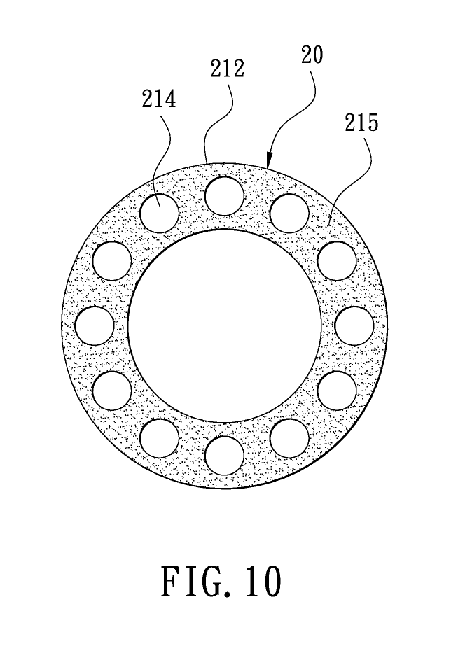

FIG. 10 is a top view showing the illuminating module according to a fourth embodiment of the present invention. The mat toy 100 of the fourth embodiment is substantially similar to the first embodiment with the exceptions described hereinafter. A top surface of the light guide plate 21 has at least one light-previous portion 214 and an opaque textured surface 215 excluding the light-previous portion 214. Thus, when the illuminating member 23 starts to illuminate, the light will be blocked by the textured surface 215 and only radiates through the light-previous portion 214 to provide multiple dot light sources. Transmit

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A mat toy, comprising a mat, at least one illuminating module, and a controller;
the illuminating module being disposed on the mat and having a light guide plate, the light guide plate comprising at least one switch and at least one illuminating member;
the controller being disposed at one side of the mat and electrically connected with the switch and the illuminating member.

2. The mat toy as claimed in claim 1, wherein the mat comprises a bottom fabric, a foam layer stacked on the bottom fabric, and a top fabric stacked on the foam layer, the foam layer having at least one positioning hole, the illuminating module being disposed in the positioning hole of the foam layer.

3. The mat toy as claimed in claim 2, wherein the controller is electrically connected with the switch and the illuminating member through electric wires, the electric wires being located between the bottom fabric and the foam layer.

4. The mat toy as claimed in claim 1, wherein the light guide plate has an engaging recess at a bottom surface thereof, the switch being embedded in the engaging recess.

5. The mat toy as claimed in claim 1, wherein the light guide plate has a light guide portion around a circumferential edge thereof, the light guide portion having a notch thereon, the illuminating member being disposed in the notch.

6. The mat toy as claimed in claim 5, wherein a top surface of the light guide plate has at least one light-previous portion and an opaque textured surface excluding the light-previous portion.

7. The mat toy as claimed in claim 1, wherein the controller comprises a control unit, the control unit being electrically connected with a mode-switching switch and a sounding member.

8. A mat toy, comprising a mat, at least one illuminating module, a controller, and an infrared emitter;
the illuminating module being disposed on the mat and having a light guide plate, the light guide plate comprising at least one illuminating member;
the controller being disposed at one side of the mat and electrically connected with the illuminating member, the controller further comprising an infrared receiver thereon;
the infrared emitter being disposed at another side of the mat and corresponding in position to the infrared receiver.

9. The mat toy as claimed in claim 1, wherein the light guide plate is shaped to one of a circle and a rectangle.

10. The mat toy as claimed in claim 1, wherein the switch is a push switch.
